(19) United States
(12) Patent Application Publication
(10) Pub. No.: US 2025/0159439 A1
(43) Pub. Date: May 15, 2025

(54) COMMUNICATION SYSTEM AND METHOD

(71) Applicant: 3M INNOVATIVE PROPERTIES COMPANY, St. Paul, MN (US)

(72) Inventor: Darin K. Thompson, Huntersville, NC (US)

(21) Appl. No.: 18/838,653

(22) PCT Filed: Feb. 3, 2023
(86) PCT No.: PCT/IB2023/050988

§ 371 Date: Aug. 15, 2024

Related U.S. Application Data
(60) Provisional application No. 63/268,339, filed on Feb. 22, 2022.

(51) Int. Cl. H04W 4/08; H04W 84/20; H04W 88/06

(52) U.S. Cl. CPC H04W 4/08; H04W 84/20; H04W 88/06

(57) ABSTRACT

A communication system includes a plurality of groups of wireless units and each group includes a plurality of wireless units. Each wireless unit of each group includes a processor and is in full-duplex communication with each of the other wireless units of the corresponding group. Each wireless unit of each group is configured as one of a master unit and a slave unit of the corresponding group. The processor of the master unit of a first group forms a first intergroup communication channel with the master unit of a second group in response to a first user input to communicably couple the first group to the second group. Upon formation of the first intergroup communication channel, each slave unit of the first group is in full-duplex communication with each slave unit of the second group via the corresponding master units of the first and second groups.

### TECHNICAL FIELD

The present disclosure relates to a communication system and a method of communication.

### BACKGROUND

Personal protective equipment (PPE) articles may be used by personnel (e.g., first responders, workers, etc.) working in hazardous or potentially hazardous environments and/or industrial environments. Some PPE articles may typically include wireless communication functionality that enables PPE articles to communicate with each other, or with a network, or a remote server. Wireless communication has become critical for the personnel when responding to an emergency or when working in industrial environments. For example, a team leader of a team may need to communicate with other team members who carry out commands/tasks provided by the team leader in order to address the emergency.

Generally, the team may utilize various types of PPE articles when carrying out the tasks that may be challenging for the existing communication systems. Further, the existing communication systems (e.g., DECT technology) may allow only a predefined number of team members to communicate bidirectionally with each other within the team. This may limit a size of the team or the number of team members that may communication bidirectionally with each other within the team.

### SUMMARY

In one aspect, a communication system is described. The communication system includes a plurality of groups of wireless units. Each group includes a plurality of wireless units. Each wireless unit of each group includes a processor and is in full-duplex communication with each of the other wireless units of the corresponding group. Each wireless unit of each group is configured as one of a master unit and a slave unit of the corresponding group, such that only one wireless unit of each group is configured as the master unit of the corresponding group. Each slave unit of each group is restricted to direct wireless communication with only the other wireless units of the corresponding group. The processor of the master unit of a first group from the plurality of groups forms a first intergroup communication channel with the master unit of at least a second group from the plurality of groups in response to at least a first user input to communicably couple the first group to the second group. Upon formation of the first intergroup communication channel, each slave unit of the first group is in full-duplex communication with each slave unit of the second group via the master unit of the first group and the master unit of the second group.

In another aspect, a method of communication is described. The method includes forming a plurality of groups of wireless units. Each group includes a plurality of wireless units. Each wireless unit of each group includes a processor and is in full-duplex communication with each of the other wireless units of the corresponding group. The method further includes configuring each wireless unit of each group as one of a master unit and a slave unit of the corresponding group, such that only one wireless unit of each group is configured as the master unit of the corresponding group. The method further includes restricting each slave unit of each group to direct wireless communication with only the other wireless units of the corresponding group. The method further includes forming, via the processor of the master unit of a first group from the plurality of groups, a first intergroup communication channel with the master unit of at least a second group in response to at least a first user input to communicably couple the first group to the second group. The method further includes allowing, via the master unit of the first group and the master unit of the second group, full-duplex communication between each slave unit of the first group and each slave unit of the second group upon formation of the first intergroup communication channel.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic block diagram illustrating an example of a communication system, in accordance with techniques of this disclosure;

FIG. 2 is a block diagram illustrating an example of the communication system of FIG. 1 including a first group and a second group, in accordance with techniques of this disclosure;

FIG. 3 is a block diagram illustrating an example of the communication system of FIG. 2 in a different communication configuration, in accordance with techniques of this disclosure;

FIG. 4 is a block diagram illustrating another example of the communication system of FIG. 1, in accordance with techniques of this disclosure;

FIG. 5 is a block diagram illustrating an example of the communication system of FIG. 4 in a different communication configuration, in accordance with techniques of this disclosure;

FIG. 6 is a block diagram illustrating another example of the communication system of FIG. 1, in accordance with techniques of this disclosure;

FIG. 7 is a block diagram illustrating another example of the communication system of FIG. 1, in accordance with techniques of this disclosure; and

FIG. 8 is flow chart illustrating a method of communication, in accordance with techniques of this disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

As used herein, the term “communication” may refer to any information, data, and/or signal that is provided, transmitted, received, and/or otherwise processed by an entity, and/or that is shared or exchanged between two or more people, devices, and/or other entities.

As used herein, the term “communication channel” may refer to any means of communication that enables or supports a communication interaction or an exchange of information between two or more devices or parties. The term may also refer to a shared bus configured to allow communication between two or more devices, or to a point-to-point communication link configured to allow communication between only two devices or parties.

As used herein, the term “intergroup communication channel” may refer to any means of communication that enables or supports a communication interaction or an exchange of information between two or more groups of devices or parties. The term may also refer to a shared bus configured to allow communication between two or more groups of devices, or to a point-to-point communication link configured to allow communication between only two devices or parties that are a part of different groups such that the two devices or parties may redirect communication among the other members of the respective groups.

As used herein, the term “voice communication channel” may refer to any means of communication that enables or supports a voice communication interaction between two or more devices or parties. The term may also refer to a shared bus configured to allow voice communication between two or more devices, or to a point to point communication link configured to allow voice communication between only two devices or parties.

As used herein, the terms “network” and “communication network” may be associated with transmission of messages, packets, signals, and/or other forms of information between and/or within one or more network devices. In some examples, the network may include one or more wired and/or wireless networks operated in accordance with any communication standard that is or becomes known or practicable.

As used herein, the term “duplex” may refer to a point-to-point communication system composed of two or more connected parties or devices that can communicate with one another in both directions.

As used herein, the term “full-duplex” may describe that a pair of communication devices with full-duplex communication capability may transmit data or signals to each other simultaneously using a common wireless communication channel.

As used herein, the term “direct wireless communication” may refer to any means of communication between two or more devices or parties that exists when a communication link is established between the two or more devices or parties (without using any routing or other intervening device).

According to aspects of this disclosure, a communication system includes a plurality of groups of wireless units. Each group includes a plurality of wireless units. Each wireless unit of each group includes a processor and is in full-duplex communication with each of the other wireless units of the corresponding group. Each wireless unit of each group is configured as one of a master unit and a slave unit of the corresponding group, such that only one wireless unit of each group is configured as the master unit of the corresponding group. Each slave unit of each group is restricted to direct wireless communication with only the other wireless units of the corresponding group. The processor of the master unit of a first group from the plurality of groups forms a first intergroup communication channel with the master unit of at least a second group from the plurality of groups in response to at least a first user input to communicably couple the first group to the second group. Upon formation of the first intergroup communication channel, each slave unit of the first group is in full-duplex communication with each slave unit of the second group via the master unit of the first group and the master unit of the second group.

The processor of the master unit of the first group forms the first intergroup communication channel with the master unit of the second group to communicably couple the first group to the second group. Thus, the first group and the second group may be communicably coupled to each other that enables increase in a number of wireless units that can communicate with each other. This may enable the communication system to increase the number of wireless units that may communicate with each other even if a size of each group is restricted (e.g., through direct wireless communication). Further, each group may include a plurality of wireless units that may allow multiple types of PPE articles to be connected with each other within each group. Moreover, any number of separate groups of wireless units can communicate with each other via the respective master units. Therefore, the present disclosure may allow intergroup communication. Such intergroup communication may be required in certain work environments and/or emergency situations.

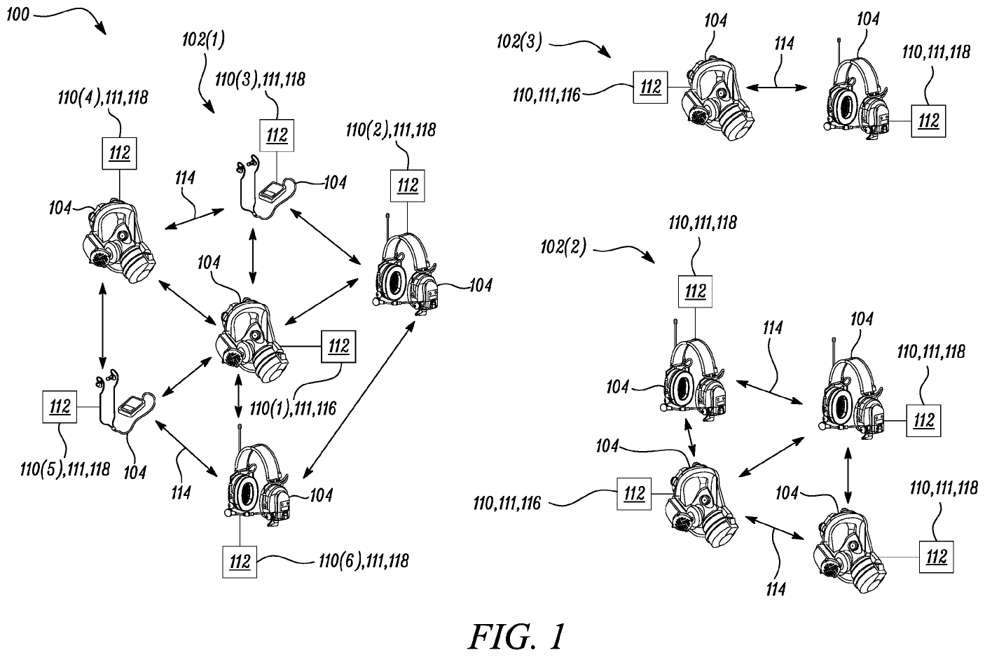

FIG. 1 is a schematic block diagram illustrating an example of a communication system 100. The communication system 100 includes a plurality of groups of wireless units 102(1), 102(2), . . . , 102(N) (collectively referred to as “groups 102”), where N is an integer corresponding to a total number of groups of wireless units 102 in the communication system 100 (e.g., N=1, 2, 3, etc.). The plurality of groups of wireless units 102 is interchangeably referred to hereinafter as “the groups 102”. In the illustrated embodiment of FIG. 1, N=3.

Each group 102 includes a plurality of wireless units 110(1), 110(2), . . . , 110(M) (collectively referred to as “wireless units 110”) connected to each other, where M is an integer corresponding to a total number of wireless units 110 in the corresponding group of wireless units 102 (e.g., M=4, 6, 8, etc.). In some embodiments, each group of wireless units 102 may include same or different number of wireless units 110. In the illustrated example of FIG. 1, three groups 102, i.e., group 102(1), group 102(2) and group 102(3), are shown for the purpose of illustration, however, the communication system 100 may include any number of groups of wireless units 102.

In some examples, the communication system 100 further includes a plurality of personal protective equipment (PPE) articles 104. Each wireless unit 110 of each group 102 is associated with a corresponding PPE article 104 from the plurality of PPE articles 104. Thus, the communication system 100 may allow multiple types of PPE articles 104 to communicate with each other within each group 102.

In some examples, each PPE article 104 may be used to protect a user from harm or injury from a variety of factors in an environment. In some examples, the plurality of PPE articles 104 may be used by emergency personnel, e.g., law enforcement, medical personnel, first responders, healthcare professionals, paramedics, HAZMAT workers, security personnel, or other personnel who work in potentially hazardous environments or loud environments, e.g., chemical, biological or nuclear environments, or other physical environments, e.g., construction sites, agricultural sites, mining, or manufacturing sites. In some examples, the user may utilize the PPE article 104 while engaging in tasks or activities within the environment.

Examples of such PPE articles 104 may include, but are not limited to, respiratory protection equipment with or without integrated communication system (including disposable respirators, reusable respirators, powered air purifying respirators, non-powered air purifying respirators, full-face respirators, half-mask respirators, supplied air respirators, self-contained breathing apparatus, etc.), protective eyewear (with or without communication function), such as visors, goggles, filters or shields (any of which may include augmented reality functionality), protective headwear (with or without hearing protection), such as hard hats, hoods or helmets, hearing protection (including in ear hearing protection, ear plugs and ear muffs), protective shoes, protective gloves, other protective clothing, such as coveralls and aprons, protective articles, such as sensors, safety tools, detectors, global positioning devices, mining cap lamps, fall protection harnesses, exoskeletons, self-retracting lifelines, heating and cooling systems, gas detectors, and any other suitable gear configured to protect the user from injury. As used herein, the term “protective equipment” may include any type of equipment or clothing that may be used to protect the user from hazardous or potentially hazardous conditions. In the illustrated example of FIG. 1, only some examples of PPE articles 104 are shown for the purpose of illustration without limiting the present disclosure with a type of PPE article.

Each wireless unit 110 of each group 102 includes a processor 112 and is in full-duplex communication with each of the other wireless units 110 of the corresponding group 102. In some embodiments, the full-duplex communication may be similar to a telephone system wherein receiving and transmitting paths are both open and both parties can speak to each other simultaneously. In some examples, each wireless unit 110 of each group 102 is in full-duplex communication with each of the other wireless units 110 of the corresponding group 102 via one or more of wireless and/or wired communication interfaces (not shown) using one or more communication protocols. For example, in group 102(1), the wireless unit 110(2) is in full-duplex communication with the wireless unit 110(1) as well as the wireless units 110(3)-110(6) via one or more of wireless and/or wired communication interfaces.

In some examples, the wireless units 110 of each group 102 are in full-duplex communication with each other if a total number of wireless units 110 of the corresponding group 102 is less than or equal to a predetermined threshold number (e.g., 10). Thus, the number of wireless units 110 in one group 102 may be limited by the predetermined threshold number.

In some examples, the processor 112 may be embodied in a number of different ways. For example, the processor 112 may be embodied as various processing means, such as one or more of a microprocessor or other processing elements, a coprocessor, or various other computing or processing devices, including integrated circuits, such as, for example, an ASIC (application specific integrated circuit), an FPGA (field programmable gate array), or the like. In some examples, the processor 112 may be configured to execute instructions stored in a memory (not shown) or otherwise accessible to the processor 112. In some examples, the memory may include a cache or random-access memory for the processor 112. Alternatively, or in addition, the memory may be separate from the processor 112, such as a cache memory of a processor, a system memory, or other memory.

As such, whether configured by hardware or by a combination of hardware and software, the processor 112 may represent an entity (e.g., physically embodied in circuitry—in the form of processing circuitry) capable of performing operations according to some embodiments while configured accordingly. Thus, for example, when the processor 112 is embodied as an ASIC, FPGA, or the like, the processor 112 may have specifically configured hardware for conducting the operations described herein. Alternatively, as another example, when the processor 112 may be embodied as an executor of software instructions, the instructions may specifically configure the processor 112 to perform the operations described herein.

In some examples, each wireless unit 110 includes a memory (not shown). In some examples, the memory may be configured to store data, such as user identification, device identification, operational data of the wireless unit 110, software, audio/video data, etc. The functions, acts or tasks illustrated in the figures or described herein may be performed by the processor 112 executing the instructions stored in the memory. The functions, acts or tasks may be independent of a particular type of instruction set, a storage media, a processor or processing strategy and may be performed by a software, a hardware, an integrated circuit, a firmware, a micro-code and/or the like, operating alone or in combination. Likewise, the processing strategies may include multiprocessing, multitasking, parallel processing, and/or the like.

In some examples, the memory may be a main memory, a static memory, or a dynamic memory. The memory may include, but may not limited to, computer readable storage media, such as various types of volatile and non-volatile storage media, including, but not limited to, random access memory (RAM), read-only memory (ROM), programmable read-only memory, electrically programmable read-only memory (EPROM), electrically erasable programmable read-only memory (FEPROM), flash memory, magnetic tape or disk, optical media, and/or the like.

In some examples, the processor 112 of each wireless unit 110 is communicably coupled to the one or more of wireless and/or wired communication interfaces. In some examples, the wireless units 110 of each group 102 are disposed in full-duplex communication with each other via a first communication protocol 114. Communication may include but is not limited to voice and/or data communication.

In some examples, the first communication protocol 114 may include one or more wireless communication protocols, such as Wi-Fi, Bluetooth®, infrared, Zigbee, wireless universal serial bus (USB), near-field communication (NFC), RFID protocols, or generally any wireless communication protocol. In some examples, the first communication protocol 114 is digital enhanced cordless telecommunications (DECT) protocol. For example, the communication system 100 may support DECT communication without the need for a fixed based station, e.g., allowing for mobility without fixed base station. In some other embodiments, a custom DECT protocol may be utilized. A custom DECT protocol as referred to herein may include, but is not limited to, an ability to break a group into multiple sub-groups.

In some examples, the wireless units 110 of each group 102 may communicate through a communication network. In some examples, the communication network may include a circuit-switched voice network, a packet-switched data network, or any other network capable for carrying electronic communication. For example, the communication network may include networks based on the Internet protocol (IP) or asynchronous transfer mode (ATM), etc.

In some examples, the communication network may include one or more of a wireless network, a wired network, a local area network (LAN), a metropolitan area network (MAN), a wide area network (WAN), a wireless personal area network (WPAN), a mobile network, a Virtual Private Network (VPN), public switched telephone network (PSTN), 802.11, 802.16, 802.20, WiMax networks, and/or the like, and may include a set of interconnected networks that make up the Internet. In some examples, the wireless network may include, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc.

Examples of the communication network may further include, but are not limited to, a personal area network (PAN), a storage area network (SAN), a home area network (HAN), a campus area network (CAN), an enterprise private network (EPN), Internet, a global area network (GAN), satellite network such as a Global Positioning System (GPS) network, and so forth. Examples are intended to include or otherwise cover any type of network, including known, related art, and/or later developed technologies to connect the wireless units 110 of each group 102.

Each wireless unit 110 of each group 102 is configured as one of a master unit 116 and a slave unit 118 of the corresponding group 102, such that only one wireless unit 110 of each group 102 is configured as the master unit 116 of the corresponding group 102. Each slave unit 118 of each group 102 is restricted to direct wireless communication with only the other wireless units 110 of the corresponding group 102. In some examples, each slave unit 118 of each group 102 communicates with the master unit 116 at least to join the corresponding group 102. In some examples, the master unit 116 may add or remove slave units 118 from the corresponding group 102.

In some examples, the direct wireless communication may be implemented using RF signals, infrared signals, or any other suitable wireless communication signals. Moreover, the direct wireless communication can be implemented in accordance with any suitable communication protocol. For example, the direct wireless communication may be implemented in accordance with a wireless personal area network (PAN) protocol, such as IEEE 802.15, Bluetooth® or Zigbee. In another example, the direct wireless communication may be implemented in accordance with a wireless networking protocol, such as 802.11, 802.16 (WiMAX) and/or the like.

In some examples, each wireless unit 110 corresponds at least to a user (not shown), i.e., a member of the group 102. The member may be a crew member or a crew leader. In some examples, the crew leader in each group 102 corresponds to the master unit 116 of the corresponding group 102. For example, a crew leader may carry the wireless unit 110 that is configured as the master unit 116 of the corresponding group 102 and is joined by other crew members, each carrying the wireless unit 110 configured as the slave unit 118, to form the corresponding group 102, e.g., a group of members with a crew leader and at least a crew member. In another non-limiting example, a crew member may take the role of the crew leader, e.g., when the crew leader is lost or leaves the group 102.

In some examples, if the wireless unit 110 that is currently the master unit 116 leaves the group 102, another wireless unit 110 in that group 102 or another wireless unit 110 not in that group 102 may become the new master unit 116. If multiple wireless units 110 are separated from the group 102 and split into multiple groups 102 (e.g., based on a strength of communication link between the wireless units 110 within the group 102), each group 102 is adapted to include the master unit 116 and may function as an independent group 102 from the remaining groups 102 in the communication system 100. Further, in some examples, when wireless units 110 of the multiple groups 102 return to an area within a predefined range, the separate groups may rejoin into one group 102 again.

In some examples, each wireless unit 110 of each group 102 includes a wireless unit identification 111 associated with the corresponding wireless unit 110. The processor 112 of the master unit 116 of each group 102 is configured to add or remove one or more slave units 118 from the corresponding group 102 based on the wireless unit identification 111 of the one or more slave units 118. In some examples, the groups 102 may be formed via touch pairing between the one or more slave units 118 and the master unit 116 of that corresponding group 102, e.g., via NFC. In some examples, the wireless unit identification 111 may include numbers, letters, characters, symbols, or a combination thereof.

The present disclosure is not limited to forming groups 102 only via touch pairing. Other methods of forming communication groups may be contemplated or utilized. As a non-limiting example, the groups 102 may be configured to include up to a predefined number of active members, e.g., ten active members. In addition, groups 102 may optionally have a definable minimum and/or maximum group capacity (e.g., the predetermined threshold number). In some examples, the minimum and/or maximum group capacity may be defined by the master unit 116 of the corresponding group 102. Further, forming a group, dissolving a group, splitting from a group, joining a group, rejoining a group, and reforming a group, new member additions/deletions, continuous voice communication, and all other process performed according to the principles of the present disclosure may be provided via a wide range of communication technologies.

In the illustrated example of FIG. 1, in the group 102(1), the wireless unit 110(1) is assigned or configured as the master unit 116 and each of the other wireless units 110(2)-110(6) are assigned or configured as the slave units 118. Thus, the wireless unit 110(1) of the group 102(1) may be referred to as the crew leader of the group 102(1). Further, the wireless unit 110(1) may add or remove one or more of the other wireless units 110(2)-110(6) (i.e., the slave units 118) from the group 102(1) based on the wireless unit identification 111 associated with the corresponding wireless unit 110.

In some examples, the crew leader (e.g., the wireless unit 110(1) of the group 102(1)) may issue and store (e.g., in the memory) the wireless unit identification 111 associated with each of the wireless units 110 of the corresponding group 102 as group information. The crew member (e.g., the wireless units 110(2)-110(6) of the group 102(1)) may receive the group information from the crew leader. In other words, each wireless unit 110 of each group 102 may have access to the wireless unit identifications 111 of the crew members of the corresponding group 102. Thus, each slave unit 118 may be able to take the role of the master unit 116, e.g., when the current master unit 116 is lost or leaves the corresponding group 102.

Although the non-limiting example of the group 102(1) of FIG. 1 includes five wireless units 110 as slave units 118 and the wireless unit 110(1) as the master unit 116 of the group 102(1), the present disclosure is not limited to having a group with only six wireless units 110. In other words, the groups 102 may have more than or fewer than six wireless units 110 (e.g., the group 102(2) or the group 102(3)). Further, one-to-all communication is supported, i.e., each crew member may be in communication with each of the remaining crew members in the corresponding group 102, e.g., without the need of communicating via the crew leader.

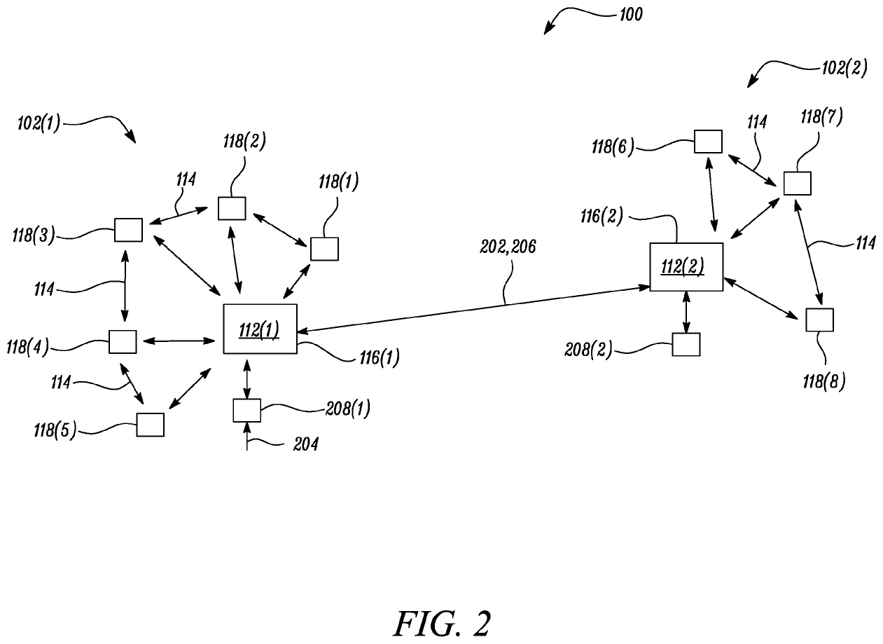

FIG. 2 is a block diagram illustrating an example of the communication system 100. Only two groups 102(1), 102(2) are shown in FIG. 2 for illustrative and descriptive purposes. The group 102(1) is interchangeably referred to hereinafter as a first group 102(1) and the group 102(2) is interchangeably referred to hereinafter as a second group 102(2). The first group 102(1) and the second group 102(2) include the corresponding master units 116(1), 116(2) (collectively, master units 116) and the corresponding slave units 118(1)-118(5), 118(6)-118(8) (collectively, slave units 118). Further, the master unit 116(1) includes the processor 112(1) and the master unit 116(2) includes the processor 112(2). It is to be understood that the plurality of groups of wireless units 102 may include a number of groups 102, however, only groups 102(1), 102(2) are shown for illustrative and descriptive purposes.

The processor 112(1) of the master unit 116(1) of the first group 102(1) from the plurality of groups 102 forms a first intergroup communication channel 202 with the master unit 116(2) of at least the second group 102(2) from the plurality of groups 102 in response to at least a first user input 204 to communicably couple the first group 102(1) to the second group 102(2). The first intergroup communication channel 202 may be established between only the master units 116(1), 116(2) of the corresponding groups 102(1), 102(2). In some examples, the first intergroup communication channel 202 is a voice communication channel.

In some examples, the master unit 116 of each group 102 includes a user interface 208 communicably coupled to the processor 112 of the master unit 116. In some examples, a user (e.g., the crew leader) of the master unit 116 of each group 102 may have access to the corresponding user interface 208. In the illustrated embodiment of FIG. 2, the processor 112(1) of the master unit 116(1) of the first group 102(1) is communicably coupled to the user interface 208(1) and the processor 112(2) of the master unit 116(2) of the second group 102(2) is communicably coupled to the user interface 208(2). The user interfaces 208(1), 208(2) are collectively referred to herein as “the user interface 208”.

In some examples, the user interface 208(1) of the master unit 116(1) of the first group 102(1) is configured to receive the first user input 204 from the user (not shown) of the master unit 116(1) of the first group 102(1) indicative of a request to communicably couple the first group 102(1) to the second group 102(2). In some examples, the user interface 208 may include a display, lights, buttons, keys (such as arrow or other indicator keys). In some examples, the first user input 204 includes at least one of a voice input, a touch-based input, a gesture-based input, and a button press. In some examples, the user interface 208 may include the necessary hardware and software to perform the intended functions as described herein.

In some examples, each user interface 208 may output a list of groups 102 from the plurality of groups 102 that are nearby or otherwise accessible for connection (e.g., available on a same network). In some examples, the user interface 208 may allow the master unit 116 of each group 102 to form intergroup communication channels simultaneously or otherwise with multiple other groups 102 from the plurality of groups 102 of the communication system 100. For example, the user of the master unit 116 of each group 102 may select multiple groups 102 from the list of groups 102 that are outputted by the corresponding user interface 208. In some examples, the master unit 116(1) of the first group 102(1) may automatically form the first intergroup communication channel 202 with the master unit 116(2) of the second group 102(2) based on a past history of connection between first group 102(1) and the second group 102(2) as stored by the master units 116(1), 116(2) of the corresponding first and second groups 102(1), 102(2). It should be noted that the function and features described herein with reference to the master unit 116(1) of the first group 102(1) may be equally applicable to all the other master units 116 of the corresponding groups 102 from the plurality of groups 102.

In some examples, each user interface 208 may be able to provide alerts to the user of the master unit 116 in a variety of ways, such as by sounding an alarm or providing haptic feedback. In some examples, the user interface 208 may be used for a variety of functions. For example, the user of the master unit 116 may be able to modify one or more parameters associated with the corresponding group 102, such as, a total number of members in the corresponding group 102, approve or reject member connection requests, acknowledge or snooze an alert, etc.

Upon formation of the first intergroup communication channel 202, each slave unit 118(1)-118(5) of the first group 102(1) is in full-duplex communication with each slave unit 118(6)-118(8) of the second group 102(2) via the master unit 116(1) of the first group 102(1) and the master unit 116(2) of the second group 102(2). Thus, the crew members of the first and second groups 102(1), 102(2) (i.e., slave units 118(1)-118(8)) may communicate with each other via the crew leaders (i.e., master units 116(1), 116(2)) of the corresponding groups 102(1), 102(2). It should be noted that each slave unit 118(1)-118(5) of the first group 102(1) may communicate with each slave unit 118(6)-118(8) of the second group 102(2) via the master units 116(1), 116(2) only, and each slave unit 118(1)-118(5) of the first group 102(1) may be restricted to direct wireless communication with only the other members (i.e., the slave units 118(1)-118(5) and the master unit 116(1)) of the first group 102(1). Similarly, each slave unit 118(6)-118(8) of the second group 102(2) may be restricted to direct wireless communication with only the other members (i.e., the slave unit 118(6)-118(8) and the master unit 116(2)) of the second group 102(2).

In some examples, the first intergroup communication channel 202 may enable each slave unit 118(1)-118(5) of the first group 102(1) to communicably couple with each slave unit 118(6)-118(8) of the second group 102(2), thereby allowing an increase in a number of wireless units 110 that may communicate with each other even if a size of each group 102 is restricted based on the predetermined threshold number.

In some examples, the first intergroup communication channel 202 between the master unit 116(1) of the first group 102(1) and the master unit 116(2) of the second group 102(2) is formed using a second communication protocol 206 different from the first communication protocol 114. In some examples, the first intergroup communication channel 202 may enable voice and/or data communication between the master units 116(1), 116(2) of the corresponding groups 102(1), 102(2), and thus, between the slave units 118(1)-118(5), 118(6)-118(8) of the corresponding groups 102(1), 102(2).

In some examples, the second communication protocol 206 may include one or more wireless communication protocols, such as Wi-Fi, Bluetooth®, infrared, Zigbee, wireless universal serial bus (USB), near-field communication (NFC), RFID protocols, or generally any wireless communication protocol. In some examples, the second communication protocol 206 may be digital enhanced cordless telecommunications (DECT) protocol.

In some examples, the second communication protocol 206 is or supports at least one of a cellular communication, a Bluetooth protocol, and a Wi-Fi protocol. In some examples, the cellular communication may employ various technologies including enhanced data rates for global evolution (EDGE), general packet radio service (GPRS), global system for mobile communications (GSM), Internet protocol multimedia subsystem (IMS), universal mobile telecommunications system (UMTS), etc.

In some examples, the master units 116(1), 116(2) of the corresponding groups 102(1), 102(2) may communicate through a communication network. In some examples, the communication network may include a circuit-switched voice network, a packet-switched data network, or any other network capable for carrying electronic communication. For example, the communication network may include networks based on the Internet protocol (IP) or asynchronous transfer mode (ATM), etc.

In some examples, the communication network may include one or more of a wireless network, a wired network, a local area network (LAN), a metropolitan area network (MAN), a wide area network (WAN), a wireless personal area network (WPAN), a mobile network, a Virtual Private Network (VPN), public switched telephone network (PSTN), 802.11, 802.16, 802.20, WiMax networks, and/or the like, and may include a set of interconnected networks that make up the Internet. Examples of the communication network may further include, but are not limited to, a personal area network (PAN), a storage area network (SAN), a home area network (HAN), a campus area network (CAN), an enterprise private network (EPN), Internet, a global area network (GAN), and so forth. Examples are intended to include or otherwise cover any type of network, including known, related art, and/or later developed technologies to connect the master units 116(1), 116(2) of the corresponding groups 102(1), 102(2).

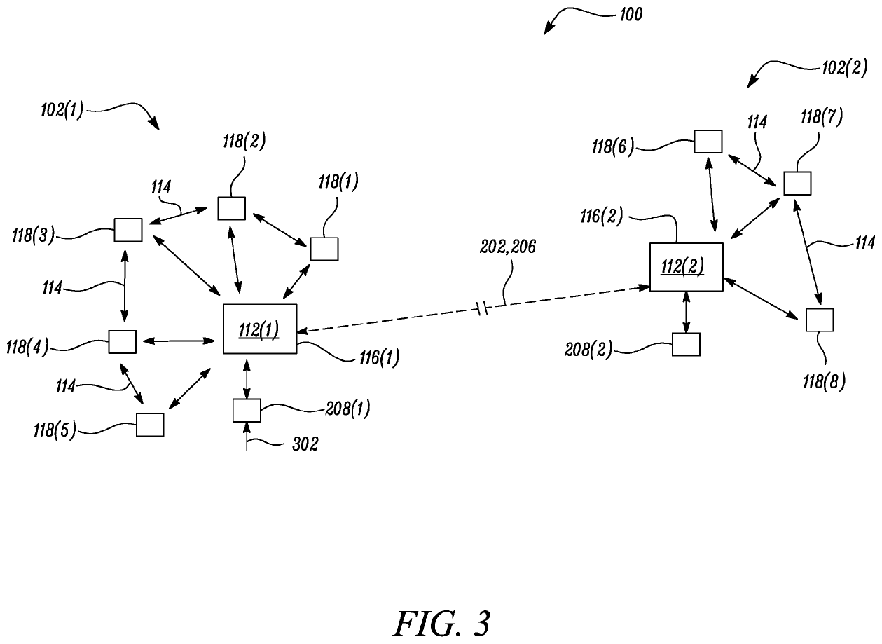

FIG. 3 is a block diagram illustrating an example of the communication system 100 including the first group 102(1) and the second group 102(2) from the plurality of groups 102. In some examples, the communication system 100 may be similar to the communication system 100 of FIG. 2. In some examples, the processor 112(1) of the master unit 116(1) of the first group 102(1) terminates the first intergroup communication channel 202 with the master unit 116(2) of the second group 102(2) from the plurality of groups 102 in response to at least a second user input 302 to terminate communication between the first group 102(1) and the second group 102(2). In some examples, the user interface 208(1) communicably coupled to the processor 112(1) of the master unit 116(1) of the first group 102(1) may receive the second user input 302 indicative of a request to terminate communication between the first group 102(1) and the second group 102(2). The user interface 208(1) may receive the second user input 302 from the user (not shown) of the master unit 116(1) of the first group 102(1).

In some examples, upon termination of the first intergroup communication channel 202, each slave unit 118(1)-118(5) of the first group 102(1) is restricted to direct wireless communication with only the other wireless units 110 (e.g., the slave units 118(1)-118(5) and the master unit 116(1)) of the first group 102(1). Similarly, upon termination of the first intergroup communication channel 202, each slave unit 118(6)-118(8) of the second group 102(2) is restricted to direct wireless communication with only the other wireless units 110 (e.g., the slave units 118(6)-118(8) and the master unit 116(2)) of the second group 102(2). Thus, the master unit 116 of each group 102 may be able to terminate an intergroup communication channel with the master units 116 of the other groups 102 from the plurality of groups 102 of the communication system 100 as and when required.

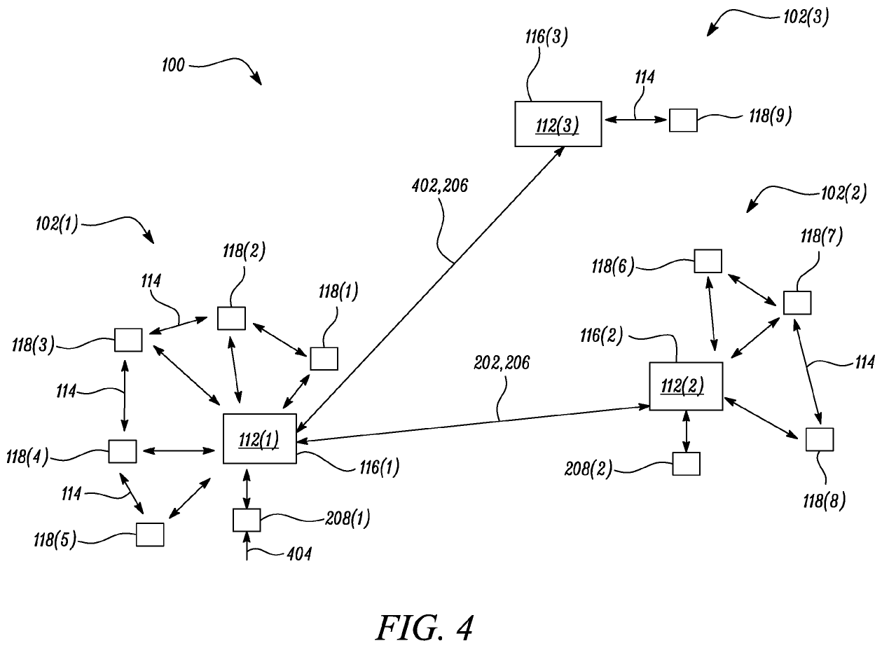

FIG. 4 is a block diagram illustrating an example of the communication system 100. In some examples, the communication system 100 may be similar to the communication system 100 of FIG. 2. In the illustrated embodiment of FIG. 4, the first group 102(1), the second group 102(2) and the group 102(3) from the plurality of groups 102 are shown for illustrative and descriptive purposes. The group 102(3) is hereinafter referred to as the third group 102(3). The third group 102(3) includes the master unit 116(3) and the slave unit 118(9). The master unit 116(3) includes the processor 112(3). The master unit 116(1) of the first group 102(1) forms the first intergroup communication channel 202 with the master unit 116(2) of the second group 102(2).

In some examples, the processor 112(1) of the master unit 116(1) of the first group 102(1) forms a second intergroup communication channel 402 with the master unit 116(3) of the third group 102(3) from the plurality of groups 102 in response to at least a third user input 404 to communicably couple the first group 102(1) to the third group 102(3). In some examples, the user interface 208(1) communicably coupled to the processor 112(1) of the master unit 116(1) of the first group 102(1) may receive the third user input 404 indicative of a request to communicably couple the first group 102(1) to the third group 102(3). The user interface 208(1) may receive the third user input 404 from the user (not shown) of the master unit 116(1) of the first group 102(1). In some examples, the second intergroup communication channel 402 between the master unit 116(1) of the first group 102(1) and the master unit 116(3) of the third group 102(3) is formed using the second communication protocol 206.

In some examples, upon formation of the second intergroup communication channel 402, each slave unit 118(9) of the third group 102(3) is in full-duplex communication with each slave unit 118(5)-118(8) of the second group 102(2) via the master unit 116(3) of the third group 102(3), the master unit 116(1) of the first group 102(1), and the master unit 116(2) of the second group 102(2). Since the master unit 116(1) of the first group 102(1) is communicably coupled to the master unit 116(2) of the second group 102(2), each slave unit 118(9) of the third group 102(3) is in full-duplex communication with each slave unit 118(5)-118(8) of the second group 102(2) as well. In some examples, upon termination of the first intergroup communication channel 202, each slave unit 118(9) of the third group 102(3) may be in full-duplex communication with each slave unit 118(1)-118(5) of the first group 102(1) only.

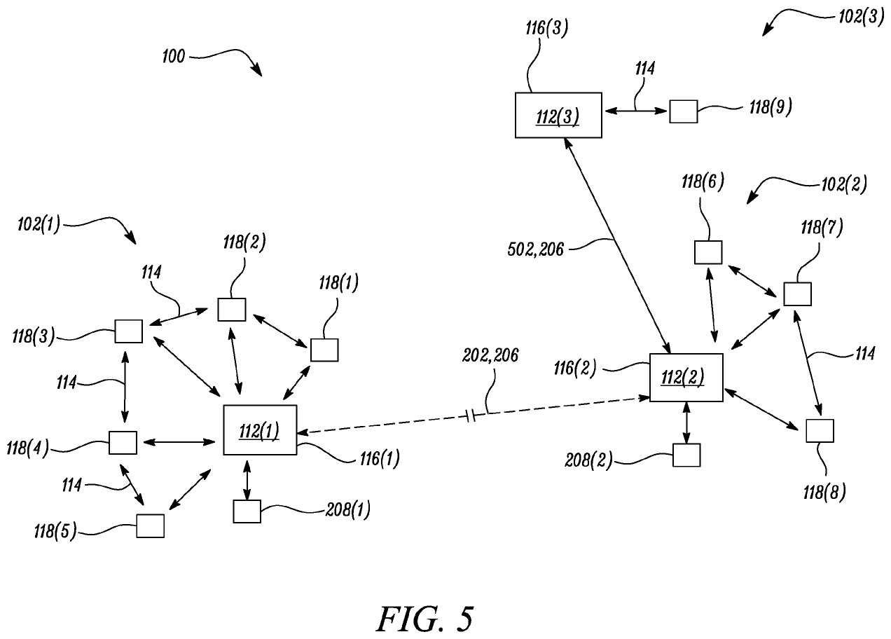

FIG. 5 is a block diagram illustrating an example of the communication system 100. In some examples, the communication system 100 may be similar to the communication system 100 of FIG. 4. In the illustrated embodiment of FIG. 5, the first group 102(1), the second group 102(2) and the third group 102(3) from the plurality of groups 102 are shown for illustrative and descriptive purposes.

In some examples, upon termination of the first intergroup communication channel 202 (e.g., due to loss of connectivity), the processor 112(3) of the master unit 116(3) of the third group 102(3) automatically forms a third intergroup communication channel 502 with the master unit 116(2) of the second group 102(2). In some examples, the third intergroup communication channel 502 between the master unit 116(3) of the third group 102(3) and the master unit 116(2) of the second group 102(2) is formed using the second communication protocol 206.

Upon formation of the third intergroup communication channel 502, each slave unit 118(9) of the third group 102(3) is in full-duplex communication with each slave unit 118(5)-118(8) of the second group 102(2) via the master unit 116(3) of the third group 102(3) and the master unit 116(2) of the second group 102(2).

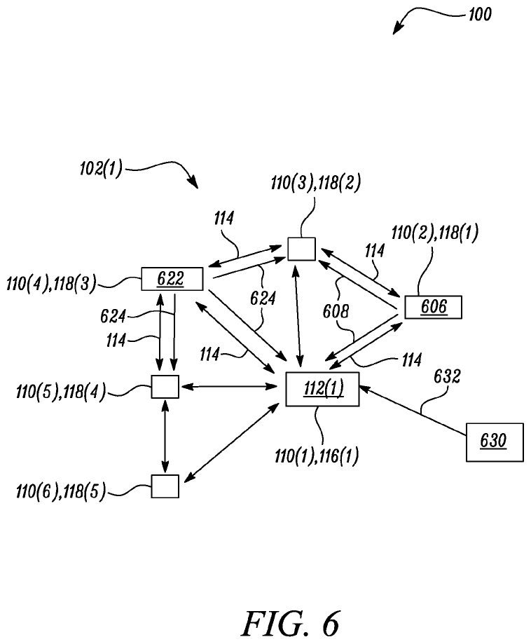

FIG. 6 is a schematic block diagram illustrating an example of the communication system 100. In the illustrated embodiment of FIG. 6, only group 102(1) is shown from the plurality of groups 102 of the communication system 100.

As shown in FIG. 6, the group 102(1) includes the plurality of wireless units 110(1)-110(6). Further, the wireless unit 110(1) is referred to as the master unit 116(1) of the group 102(1) and the wireless units 110(2)-110(6) are referred to as the slave units 118(1)-118(5). The wireless unit 110(1) includes the processor 112. It should be understood that the number of wireless units 110 in each group 102 from the plurality of groups 102 of the communication system 100 may be different based on application requirements.

In some examples, at least one wireless unit 110 of at least one group 102 (e.g., the group 102(1)) from the plurality of groups 102 includes a location sensor 606. The location sensor 606 is configured to generate a location signal 608 indicative of a location of the at least one wireless unit 110. In some examples, each of the other wireless units 110 of the at least one group 102 is configured to receive the location signal 608 from the at least one wireless unit 110 of the at least one group 102.

In the illustrated embodiment of FIG. 6, the wireless unit 110(2) of the group 102(1) includes the location sensor 606. Further, each of the other wireless units 110(1), 110(3)-110(6) of the group 102(1) may receive the location signal 608 from the wireless unit 110(2) that includes the location sensor 608. It should be noted that any number of wireless units 110 within the groups 102 may include the location sensor 608.

In some examples, the wireless unit 110(2) may generate the location signal 608 periodically, for example, every minute. In some examples, a time period between the generation of the location signals 608 may be manually configurable through the wireless unit 110(2) and/or may be automatically configurable by the master unit 116(1) of the group 102(1).

In some examples, at least one wireless unit 110 of at least one group 102 (e.g., the group 102(1)) includes an environmental sensor 622 configured to generate a detection signal 624 based on a detection of at least one environmental condition. In the illustrated embodiment of FIG. 6, the wireless unit 110(4) of the group 602(1) includes the environmental sensor 622. In some examples, the environmental sensor 622 is at least one of a gas sensor, a temperature sensor, a wind speed sensor, a wind direction sensor, and a pressure sensor.

In some examples, the environmental sensor 622 may determine a concentration or presence of at least one substance in an ambient environment of the environmental sensor 622. It should be understood that the environmental sensor 622 may be of any type including, but not limited to, digital potentiometers, resistive temperature devices (RTD), thermocouples, thermistors, infrared (IR) sensors, pressure detectors, gas detectors, radiation detectors, optical sensors, biohazard detectors, video cameras or any other environment detector.

In some examples, the environmental sensor 622 may be used to identify, detect and monitor environmental conditions, such as temperature, concentration and flow rate of hazardous substances or other substances (solid/liquid/gaseous) present in the ambient environment, biohazards, radionuclides, and/or any other hazardous or potentially hazardous environmental condition. In some examples, the environmental sensor 622 may be used to detect and monitor conditions associated with wireless units 110 of the corresponding group 102, such as equipment temperature, battery power levels, status of communication interface, and/or the like. In some examples, at least one wireless unit 110 of at least one group 102 may include other sensors, such as physiological sensors (not shown) that enable detection of a physiological condition of a user of the at least one wireless unit 110.

Each of the other wireless units 110 of the at least one group 102 is configured to receive the detection signal 624 from the at least one wireless unit 110 of the at least one group 102. In the illustrated embodiment of FIG. 6, each of the other wireless units 110(1)-110(3), 110(5)-110(6) of the group 102(1) may receive the detection signal 624 from the wireless unit 110(3) that includes the environmental sensor 622. It should be noted that any number of wireless units 110 within the group 102(1) may include the environmental sensor 622.

In some examples, the master unit 116(1) of the group 102(1) may share the locations of the wireless units 110(2)-110(6) and the at least one environmental condition with the other groups 102 from the plurality of groups 102 of the communication system 100 that are communicably coupled to the group 102(1) through an intergroup communication channel (e.g., the first intergroup communication channel 202 shown in FIG. 2, the second intergroup communication channel 402 shown in FIG. 4, and the third intergroup communication channel 502 shown in FIG. 5).

In some examples, the processor 112 of the master unit 116 of at least one group 102 (e.g., the group 102(1)) from the plurality of groups 102 is configured to receive firmware updates 632 from an external device 630 and transmit the firmware updates 632 to each slave unit 118 of the at least one group 102. In the illustrated embodiment of FIG. 6, the processor 112(1) of the master unit 116(1) of the group 102(1) is configured to receive the firmware updates 632 from the external device 630 and transmit the firmware updates 632 to each slave unit 118(1)-118(5) of the group 102(1).

In some examples, the external device 630 may be a computer system, a server, or a portable user interface device. In some examples, the computer system or the server may be in the form of a general-purpose computing device. The computer system or the server may further include other removable/non-removable, volatile/non-volatile computer system storage media.

In some cases, the external device 630 may be a smartphone or other mobile terminal, or a laptop, or any other portable computing/communication device. As such, the portable user interface device may include processing circuitry that is enabled to interface with the processor 112(1) of the master unit 116(1) of the group 102(1) to program, control or otherwise interact with the master unit 116(1). For example, the external device 630 may change device specific settings of the master unit 116(1) of the group 102(1).

In some examples, the processor 112(1) of the master unit 116(1) of the group 102(1) may communicate with the external device 630 via one or more wireless communication protocols, such as Bluetooth®, infrared, Wi-Fi, Zigbee, wireless universal serial bus (USB), radio frequency, near-field communication (NFC), RFID protocols, or generally any wireless communication protocol. In some examples, the firmware updates 632 may be transmitted to each slave unit 118(1)-118(5) of the group 102(1) through a communication network. In some examples, the communication network may include one or more of a wireless network, a wired network, a local area network (LAN), a metropolitan area network (MAN), a wide area network (WAN), a wireless personal area network (WPAN), 802.11, 802.16, 802.20, WiMax networks, a direct connection such as through a Universal Serial Bus (USB) port, and the like, and may include a set of interconnected networks that make up the Internet. In some examples, the wireless network may include, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc. In some examples, the communication network may include a circuit-switched voice network, a packet-switched data network, or any other network capable for carrying electronic communication.

Examples of the communication network may further include, but are not limited to, a personal area network (PAN), a storage area network (SAN), a home area network (HAN), a campus area network (CAN), an enterprise private network (EPN), Internet, a global area network (GAN), and so forth. Examples are intended to include or otherwise cover any type of network, including known, related art, and/or later developed technologies to connect the processor 112(1) of the master unit 116(1) of the group 102(1) with the external device 630.

It should be noted that the function and features described herein with reference to the group 102(1) may be equally applicable to all the other groups 102 (e.g., the groups 102(2), 102(3) shown in FIG. 1) from the plurality of groups 102 of the communication system 100.

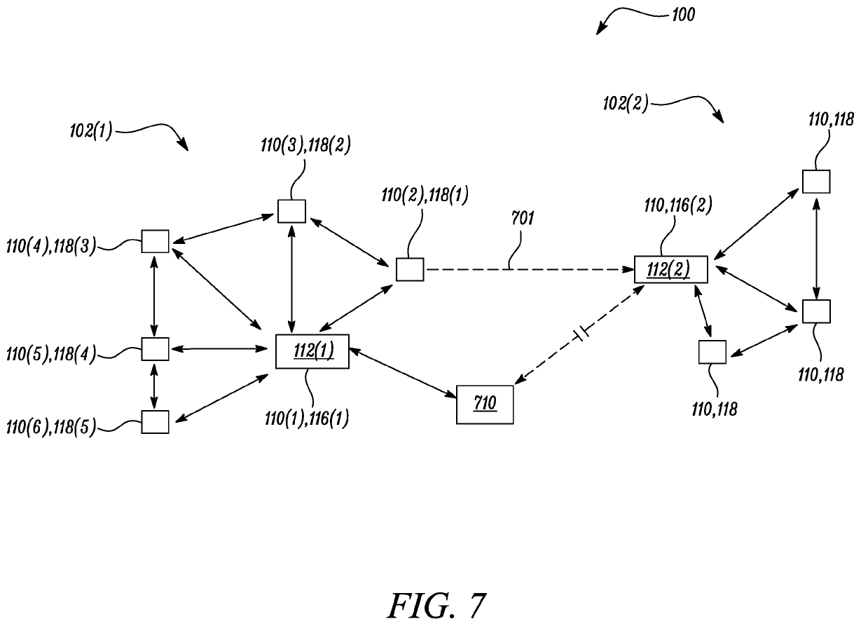

FIG. 7 is a block diagram illustrating an example of the communication system 100. In the illustrated embodiment of FIG. 7, two groups 102(1), 102(2) are shown from the plurality of groups 102 of the communication system 100.

In some examples, the wireless units 110 of each group 102(1), 102(2) are in full-duplex communication with each other if a total number of wireless units 110 of the corresponding group 102(1), 102(2) is less than or equal to the predetermined threshold number (e.g., 5). In some examples, if the total number of wireless units 110 of one group 102(1) from the plurality of groups 102 is equal to the predetermined threshold number, an additional wireless unit 710 is in a listen only mode with each wireless unit 110 of the one group 102(1). In some examples, in the listen only mode, the additional wireless unit 710 is configured to only receive signals (e.g., audio signals) from each wireless unit 110 of the one group 102(1) and is prevented from transmitting signals to the plurality of wireless units 110 of the one group 102(1). Thus, the number of wireless units 110 in one group 102 may be limited by the predetermined threshold number if the wireless units 110 of the one group 102 are in full-duplex communication with each other.

In some examples, a slave unit 118 may leave one group 102 from the plurality of groups 102 and join another group 102 from the plurality of groups 102. In some examples, joining a group 102 may be described in part as a wireless unit 110 exiting one group 102 and becoming a part of another group 102 from the plurality of groups 102. In some examples, a slave unit 118 may also rejoin a group 102 from the plurality of groups 102. Rejoining a group 102 may be described in part as a wireless unit 110 becoming a part of a group 102 which the wireless unit 110 had previously joined earlier.

For example, the slave unit 118(1) from the group 102(1) may join the group 102(2) (as indicated by an arrow 701). In such a case, the slave unit 118(1) may be automatically removed from the group 102(1), e.g., through the processor 112(1) of the master unit 116(1) of the group 102(1). It should be understood that each slave unit 118 may be a part of only one group 102 at a time. Further, the processor 112(2) of the master unit 116(2) of the group 102(2) may accept or reject (e.g., through a user interface) joining of the slave unit 118(1) into the group 102(2). In some examples, the processor 112(1) of the master unit 116(1) of the group 102(1) may also remove the slave unit 118(1) from the group 102(1) when desired. Further, in some examples, if the master unit 116(1) of the group 102(1) may leave the group 102(1), the group 102(1) may assign a new master 116 of the group 102(1) from the other slave units 118 of the group 102(1).

In another example, the additional wireless unit 710 may initially be part of the group 102(2). The additional wireless unit 710 may send a request to the master unit 116(1) of the group 102(1) indicative of joining the group 102(1). In some cases, the processor 112(2) of the master unit 116(2) automatically removes the additional wireless unit 710 from the group 102(2) prior to allowing the additional wireless unit 710 to join the group 102(1). In some other cases, the additional wireless unit 710 may remove itself from the group 102(2) prior to sending the request to the master unit 116(1) of the group 102(1) indicative of joining the group 102(1). In some other cases, the master unit 116(2) of the group 102(2) may automatically remove the additional wireless unit 710 from the group 102(2) when the additional wireless unit 710 sends the request to the master unit 116(1) of the group 102(1) indicative of joining the group 102(1).

It should be understood that each feature of the wireless units 110, e.g., joining, rejoining, leaving, may be performed automatically, semi-automatically, manually, remotely, or locally.

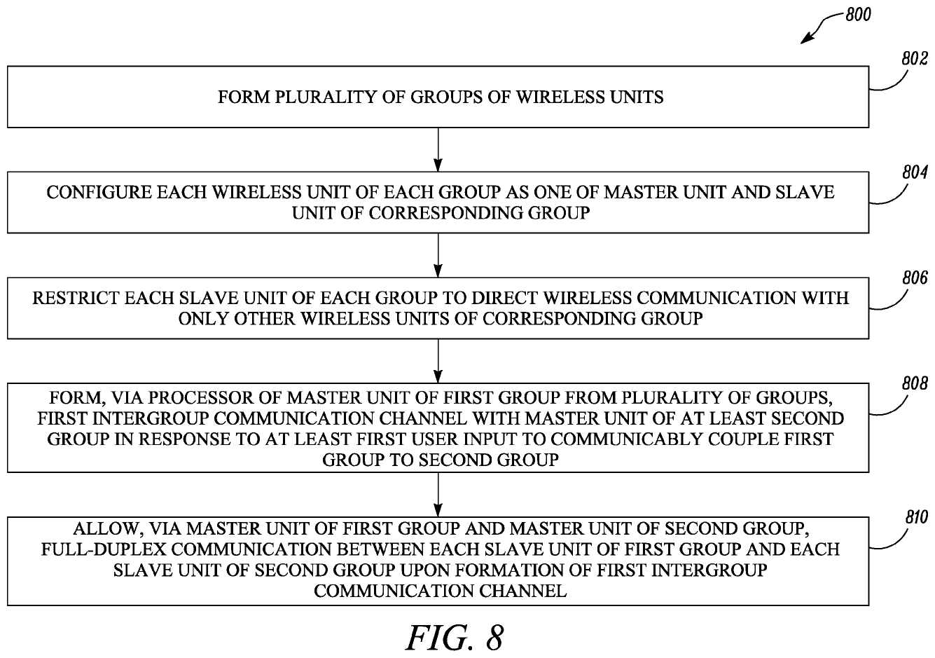

FIG. 8 is a flow chart illustrating a method 800 of communication. The method 800 may be implemented using the communication system 100 of FIGS. 1-7 incorporating the teachings of the present disclosure.

At step 802, the method 800 includes forming the plurality of groups of wireless units 102. Each group 102 includes the plurality of wireless units 110. Each wireless unit 110 of each group 102 includes the processor 112 and is in full-duplex communication with each of the other wireless units 110 of the corresponding group 102. In some examples, the method 800 further includes associating each wireless unit 110 of each group 102 with the corresponding personal protective equipment (PPE) article 104.

At step 804, the method 800 further includes configuring each wireless unit 110 of each group 102 as one of the master unit 116 and the slave unit 118 of the corresponding group 102, such that only one wireless unit 110 of each group 102 is configured as the master unit 116 of the corresponding group 102.

At step 806, the method 800 further includes restricting each slave unit 118 of each group 102 to direct wireless communication with only the other wireless units 110 of the corresponding group 102.

At step 808, the method 800 further includes forming, via the processor 112(1) of the master unit 116(1) of the first group 102(1) from the plurality of groups 102, the first intergroup communication channel 202 with the master unit 116(2) of at least the second group 102(2) in response to at least the first user input 204 to communicably couple the first group 102(1) to the second group 102(2). In some examples, the method 800 further includes receiving, via the user interface 208(1), the first user input 204 from the user of the master unit 116(1) of the first group 102(1) indicative of a request to communicably couple the first group 102(1) to the second group 102(2). In some examples, the first user input 204 includes at least one of a voice input, a touch-based input, a gesture-based input and a button press.

At step 810, the method 800 further includes allowing, via the master unit 116(1) of the first group 102(1) and the master unit 116(2) of the second group 102(2), full-duplex communication between each slave unit 118 of the first group 102(1) and each slave unit 118 of the second group 102(2) upon formation of the first intergroup communication channel 202.

In some examples, the method 800 further includes terminating, via the processor 112(1) of the master unit 116(1) of the first group 102(1), the first intergroup communication channel 202 with the master unit 116(2) of the second group 102(2) from the plurality of groups 102 in response to at least the second user input 302 to terminate communication between the first group 102(1) and the second group 102(2). In some examples, the method 800 further includes restricting each slave unit 118 of the first group 102(1) to direct wireless communication with only the other wireless units 110 of the first group 102(1) upon termination of the first intergroup communication channel 202.

In some examples, the method 800 further includes forming, via the processor 112(1) of the master unit 116(1) of the first group 102(1), the second intergroup communication channel 402 with the master unit 116(3) of the third group 102(3) from the plurality of groups 102 in response to at least the third user input 404 to communicably couple the first group 102(1) to the third group 102(3). In some examples, the method 800 further includes allowing, via the master unit 116(3) of the third group 102(3), the master unit 116(1) of the first group 102(1), and the master unit 116(2) of the second group 102(2), full-duplex communication between each slave unit 118 of the third group 102(3) and each slave unit 118 of the second group 102(2) upon formation of the second intergroup communication channel 402.

In some examples, the method 800 further includes automatically forming, via the processor 112(3) of the master unit 116(3) of the third group 102(3), the third intergroup communication channel 502 with the master unit 116(2) of the second group 102(2) upon termination of the first intergroup communication channel 202. In some examples, the method 800 further includes allowing, via the master unit 116(3) of the third group 102(3) and the master unit 116(2) of the second group 102(2), full-duplex communication between each slave unit 118 of the third group 102(3) and each slave unit 118 of the second group 102(2) upon formation of the third intergroup communication channel 502.

In some examples, the method 800 further includes generating, via the location sensor 606 associated with at least one wireless unit 110 of at least one group 102 from the plurality of groups 102, the location signal 608 indicative of a location of the at least one wireless unit 110, Each of the other wireless units 110 of the at least one group 102 is configured to receive the location signal 608 from the at least one wireless unit 110 of the at least one group 102.

In some examples, the method 800 further includes generating, via the environmental sensor 622 associated with at least one wireless unit 110 of at least one group 102, the detection signal 624 based on a detection of at least one environmental condition. In some examples, the environmental sensor 622 is at least one of a gas sensor, a temperature sensor, a wind speed sensor, a wind direction sensor, and a pressure sensor. Each of the other wireless units 110 of the at least one group 102 is configured to receive the detection signal 624 from the at least one wireless unit 110 of the at least one group 102.

In some examples, the method 800 further includes receiving, via the processor 112 of the master unit 116 of at least one group 102 from the plurality of groups 102, the firmware updates 632 from the external device 630. In some examples, the method 800 further includes transmitting, via the processor 112 of the master unit 116, the firmware updates 632 to each slave unit 118 of the at least one group 102.

In some examples, the method 800 further includes automatically removing a slave unit 118 from one group 102 from the plurality of groups 102 prior to allowing the slave unit 118 to join another group 102 from the plurality of groups 102.

In some examples, the first intergroup communication channel 202 may enable each slave unit 118 of the first group 102(1) to communicably couple with each slave unit 118 of the second group 102(2). This may allow increase in a number of wireless units 110 that may communicate with each other even if a size of each group 102 is restricted based on predetermined threshold number. Moreover, any number of the groups 102 can communicate with each other via the respective master units 116. Therefore, the system 100 and the method 800 may allow intergroup communication. Such intergroup communication may be required in certain work environments and/or emergency situations.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A communication system comprising:
a plurality of groups of wireless units, each group comprising a plurality of wireless units, wherein each wireless unit of each group comprises a processor and is in full-duplex communication with each of the other wireless units of the corresponding group, wherein each wireless unit of each group is configured as one of a master unit and a slave unit of the corresponding group, such that only one wireless unit of each group is configured as the master unit of the corresponding group, and wherein each slave unit of each group is restricted to direct wireless communication with only the other wireless units of the corresponding group;
wherein the processor of the master unit of a first group from the plurality of groups forms a first intergroup communication channel with the master unit of at least a second group from the plurality of groups in response to at least a first user input to communicably couple the first group to the second group, and wherein, upon formation of the first intergroup communication channel, each slave unit of the first group is in full-duplex communication with each slave unit of the second group via the master unit of the first group and the master unit of the second group.

2. The communication system of claim 1, wherein the wireless units of each group are disposed in full-duplex communication with each other via a first communication protocol, and wherein the first intergroup communication channel between the master unit of the first group and the master unit of the second group is formed using a second communication protocol different from the first communication protocol.

3. The communication system of claim 2, wherein the first communication protocol is digital enhanced cordless telecommunications (DECT) protocol.

4. The communication system of claim 2, wherein the second communication protocol is or supports at least one of a cellular communication, a Bluetooth protocol, and a Wi-Fi protocol.

5. The communication system of claim 1, wherein the master unit of each group comprises a user interface communicably coupled to the processor of the master unit, and wherein the user interface of the master unit of the first group is configured to receive the first user input from a user of the master unit of the first group indicative of a request to communicably couple the first group to the second group.

6. The communication system of claim 1, wherein the first user input comprises at least one of a voice input, a touch-based input, a gesture-based input, and a button press.

7. The communication system of claim 1, wherein the processor of the master unit of the first group terminates the first intergroup communication channel with the master unit of the second group from the plurality of groups in response to at least a second user input to terminate communication between the first group and the second group, and wherein, upon termination of the first intergroup communication channel, each slave unit of the first group is restricted to direct wireless communication with only the other wireless units of the first group.

8. The communication system of claim 1, wherein the processor of the master unit of the first group forms a second intergroup communication channel with the master unit of a third group from the plurality of groups in response to at least a third user input to communicably couple the first group to the third group, and wherein, upon formation of the second intergroup communication channel, each slave unit of the third group is in full-duplex communication with each slave unit of the second group via the master unit of the third group, the master unit of the first group, and the master unit of the second group.

9. The communication system of claim 8, wherein, upon termination of the first intergroup communication channel, the processor of the master unit of the third group automatically forms a third intergroup communication channel with the master unit of the second group, and wherein, upon formation of the third intergroup communication channel, each slave unit of the third group is in full-duplex communication with each slave unit of the second group via the master unit of the third group and the master unit of the second group.

10. The communication system of claim 1, wherein the wireless units of each group are in full-duplex communication with each other if a total number of wireless units of the corresponding group is less than or equal to a predetermined threshold number, wherein, if the total number of wireless units of one group from the plurality of groups is equal to the predetermined threshold number, an additional wireless unit is in a listen only mode with each wireless unit of the one group, and wherein, in the listen only mode, the additional wireless unit is configured to only receive signals from each wireless unit of the one group and is prevented from transmitting signals to the plurality of wireless units of the one group.

11. The communication system of claim 1, further comprising a plurality of personal protective equipment (PPE) articles, wherein each wireless unit of each group is associated with a corresponding PPE article from the plurality of PPE articles.

12. The communication system of claim 1, wherein at least one wireless unit of at least one group from the plurality of groups comprises a location sensor, wherein the location sensor is configured to generate a location signal indicative of a location of the at least one wireless unit, and wherein each of the other wireless units of the at least one group is configured to receive the location signal from the at least one wireless unit of the at least one group.

13. The communication system of claim 1, wherein at least one wireless unit of at least one group comprises an environmental sensor configured to generate a detection signal based on a detection of at least one environmental condition, and wherein each of the other wireless units of the at least one group is configured to receive the detection signal from the at least one wireless unit of the at least one group.

14. The communication system of claim 13, wherein the environmental sensor is at least one of a gas sensor, a temperature sensor, a wind speed sensor, a wind direction sensor, and a pressure sensor.

15. The communication system of claim 1, wherein the processor of the master unit of at least one group from the plurality of groups is configured to receive firmware updates from an external device and transmit the firmware updates to each slave unit of the at least one group.

16. The communication system of claim 1, wherein each wireless unit of each group comprises a wireless unit identification associated with the corresponding wireless unit, and wherein the processor of the master unit of each group is further configured to add or remove one or more slave units from the corresponding group based on the wireless unit identification of the one or more slave units.

17. A method of communication comprising:
forming a plurality of groups of wireless units, each group comprising a plurality of wireless units, wherein each wireless unit of each group comprises a processor and is in full-duplex communication with each of the other wireless units of the corresponding group;
configuring each wireless unit of each group as one of a master unit and a slave unit of the corresponding group, such that only one wireless unit of each group is configured as the master unit of the corresponding group;
restricting each slave unit of each group to direct wireless communication with only the other wireless units of the corresponding group;
forming, via the processor of the master unit of a first group from the plurality of groups, a first intergroup communication channel with the master unit of at least a second group in response to at least a first user input to communicably couple the first group to the second group; and
allowing, via the master unit of the first group and the master unit of the second group, full-duplex communication between each slave unit of the first group and each slave unit of the second group upon formation of the first intergroup communication channel.

18. The method of claim 17, further comprising receiving, via a user interface, the first user input from a user of the master unit of the first group indicative of a request to communicably couple the first group to the second group.

19. The method of claim 18, wherein the first user input comprises at least one of a voice input, a touch-based input, a gesture-based input and a button press.

20. The method of claim 17, further comprising:
terminating, via the processor of the master unit of the first group, the first intergroup communication channel with the master unit of the second group from the plurality of groups in response to at least a second user input to terminate communication between the first group and the second group; and
restricting each slave unit of the first group to direct wireless communication with only the other wireless units of the first group upon termination of the first intergroup communication channel.
